(19) United States
(12) Patent Application Publication
(10) Pub. No.: US 2026/0074479 A1
(43) Pub. Date: Mar. 12, 2026

(54) MOUTH FILM DEVICE WITH POSITIONING AND WIRE-PRESSING FEATURES

(71) Applicants: Yu-Hsin Li, Changhua County (TW); Wei-Che Lee, Changhua County (TW)

(72) Inventors: Yu-Hsin Li, Changhua County (TW); Wei-Che Lee, Changhua County (TW)

(21) Appl. No.: 18/829,190

(22) Filed: Sep. 9, 2024

(51) Int. Cl. H01R 43/042

(52) U.S. Cl. CPC H01R 43/0421

(57) ABSTRACT

A mouth film device includes two mouth film bodies, each equipped with an upper locking part and a crimping part. Each upper locking part has a recessed locking groove, while each crimping part has several corresponding crimping grooves and crimping protrusions. One of the mouth film bodies has an extended surrounding plate body on the side near the crimping protrusions. When the crimping protrusions are pressed together, the surrounding plate body has corresponding recessed holes in positions corresponding to parts of the crimping grooves. The height of each recessed hole is smaller than the height of the covering piece of the crimping body. The width of each recessed hole is greater than the width of the extended plate body of the crimping body. This allows the users to quickly and accurately position the wire-pressing component during the operation of the wire crimping plier.

### FIELD OF THE INVENTION

The present invention relates to a mouth film device that combines positioning and wire-pressing features, and more particularly, to a mouth film device used for positioning wire-pressing components in wire crimping pliers.

### BACKGROUND OF THE INVENTION

As shown in FIGS. 9 to 13, this is an illustrative example of a general wire (10) crimping a wire-pressing component (11). The wire crimping plier (10) has two crimping jaws (101, 102) at the front end and two pressure plates (103, 104) at the rear end. Through a linkage mechanism, when the pressure plates (103, 104) are compressed, it causes the two crimping jaws (101, 102) to achieve a pressing effect. Therefore, by fitting different sizes of mouth films (20, 21) onto the front crimping jaws (101, 102), it can crimp wire-pressing components (11) of predetermined sizes and functional transmission lines.

However, the wire-pressing component (11) includes a crimping body (111) and a cable (12) containing transmission lines (121). The crimping body (111) is formed with an extended plate body (112) and a covering piece (113). When in use, one only needs to first fit the paired mouth films (20, 21) into the crimping jaws (101, 102) of the wire crimping plier (10). By compressing the pressure plates (103, 104), it simultaneously causes the corresponding mouth films (20, 21) fitted on the crimping jaws (101, 102) to be pressed together. Then, through the compression action of the corresponding crimping grooves (201˜204) and crimping protrusions (211˜214) set within each mouth film (20, 21), and by pre-inserting the transmission line (121) of the cable (12) into the covering piece (113) of the crimping body (111) and placing it on the appropriate crimping protrusion (213), the compression of the mouth films (20, 21) can cause the transmission line (121) of the cable (12) to be restrained by the covering piece (113) and encapsulated as one unit. (This wire crimping plier (10), wire-pressing component (11), and mouth films (20, 21) are all conventional structures, so no further elaboration is needed).

The user must use one hand to prepare to compress the pressure plates (103, 104) of the wire crimping plier (10), while the other hand must first place the crimping body (111) of the wire-pressing component (11) on the crimping protrusions (211˜214) for compression. Due to practical constraints and space limitations, it is often difficult to position and secure the crimping body (111) of the wire-pressing component (11) in the most appropriate location. As a result, after compression, the formed wire-pressing component (11) may be misaligned or distorted. Alternatively, it may cause the transmission lines (121) of the cable (12) to not be fully encapsulated within the covering piece (113) of the wire-pressing component (11), leading to issues of looseness, instability, or inaccurate transmission (particularly as shown in FIGS. 12 and 13).

In order to solve the above problems, the most common solution is to use an external positioning block (a conventional design, so it's not elaborated on or illustrated) to precisely place the crimping body (111) of the wire-pressing component (11) on the crimping protrusions (211˜214) of the mouth film (21). This ensures the key components for accurate and stable operation of the wire-pressing component (11). However, in traditional technology, the positioning block and mouth films (20, 21) are typically installed and operated as separate components. This configuration presents the following problems:

Complicated Installation: In traditional designs, the positioning block and mouth films (20, 21) need to be installed separately on the wire crimping plier (10). The mouth films (20, 21) must be installed first, followed by the positioning block. It's necessary to simultaneously fix the position and angle of both the positioning block and the corresponding mouth films (20, 21). This not only requires fixing the positioning block to one of the mouth films (20, 21) but also securing it to the wire crimping plier (10). This increases the complexity of assembly and disassembly, and can easily lead to inaccuracies or position deviations during assembly.

Precision Issues: Since the positioning block and mouth films (20, 21) are installed separately, a small mistake during the installation process can often lead to inaccurate positioning between the crimping grooves (201˜204) and crimping protrusions (211˜214). This affects the deformation of the crimping position, resulting in insufficient quality and stability when crimping the wire-pressing component (11). This is particularly noticeable for smaller or specially shaped wire-pressing components (11), affecting not only individual components but potentially other connected assembly parts as well.

Durability: Moreover, under long-term use and force applied to the wire crimping plier (10), it's highly likely that the positioning block may loosen or lose precision. This leads to inaccurate positioning of the wire-pressing component (11) between the crimping grooves (201˜204) of one mouth film (20) and the crimping protrusions (211˜214) of the other mouth film (21). This similarly causes deformation or insufficient space in the crimping area, potentially resulting in wear or detachment issues of the crimped wire-pressing component (11) over extended use. These problems reduce the overall durability and reliability of the equipment.

Increased Labor Time: As each type of wire-pressing component (11) requires corresponding mouth films (20, 21) of different styles, changing the mouth films (20, 21) necessitates changing to a different positioning block. This process of adjusting the positioning block and repeatedly securing it to the mouth films (20, 21) leads to increased labor time and quality concerns. Therefore, this type of device indeed requires significant improvement to achieve economic efficiency.

The present invention intends to provide a mouth film device that combines positioning and wire-pressing features to eliminate the shortcomings mentioned above.

### SUMMARY OF THE INVENTION

The present invention relates to a mouth film device includes two mouth film bodies, each equipped with an upper locking part and a crimping part. Each upper locking part has a recessed locking groove, while each crimping part has several corresponding crimping grooves and crimping protrusions. One of the mouth film bodies has an extended surrounding plate body on the side near the crimping protrusions. When the crimping protrusions are pressed together, the surrounding plate body has corresponding recessed holes in positions corresponding to parts of the crimping grooves. The height of each recessed hole is smaller than the height of the covering piece of the crimping body. The width of each recessed hole is greater than the width of the extended plate body of the crimping body.

A second embodiment involves one of the mouth film bodies having an extended surrounding plate body on the side near the crimping protrusions. After the crimping protrusions are pressed together, the surrounding plate body has corresponding recessed grooves in positions corresponding to parts of the crimping grooves.

The primary object of the present invention is to provide a mouth film device to quickly and accurately position the wire-pressing component during the operation of the wire crimping plier. This prevents slippage and affects the assembly between the wire-pressing component and the wire. It improves upon various issues listed in the known technology. securing device

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded perspective view of the first embodiment of the present invention;

FIG. 2 is a perspective view showing the two mouth film bodies installed on the crimping jaw, with the crimping body placed on the crimping protrusions in the first embodiment of the present invention;

FIG. 3 is a cross-sectional view showing the transmission line of the cable inserted into the covering piece of the crimping body in the first embodiment of the present invention;

FIG. 3A is another cross-sectional view from a different angle of FIG. 3;

FIG. 4 is a cross-sectional view, before pressing in the first embodiment of the present invention;

FIG. 5 is a cross-sectional view, after pressing in the first embodiment of the present invention;

FIG. 6 is a perspective view of the crimping body combined with the transmission line after pressing in the first embodiment of the present invention;

FIG. 7 is an exploded perspective view showing the replacement of different mouth film bodies in the first embodiment of the present invention;

FIG. 8 is a perspective view of the second embodiment of the present invention;

FIG. 8A is a cross-sectional view of the second embodiment of the present invention combined with the wire-pressing component;

FIG. 9 is an exploded perspective view of the conventional crimping plier;

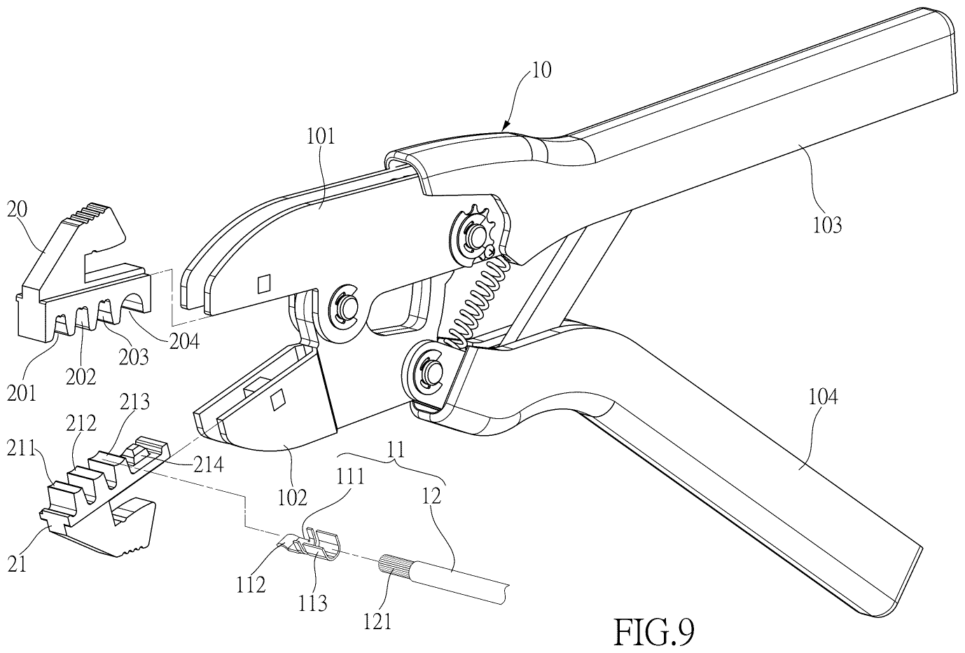

FIG. 10 is a perspective view of the operation on the wire-pressing component after assembly in the conventional crimping plier;

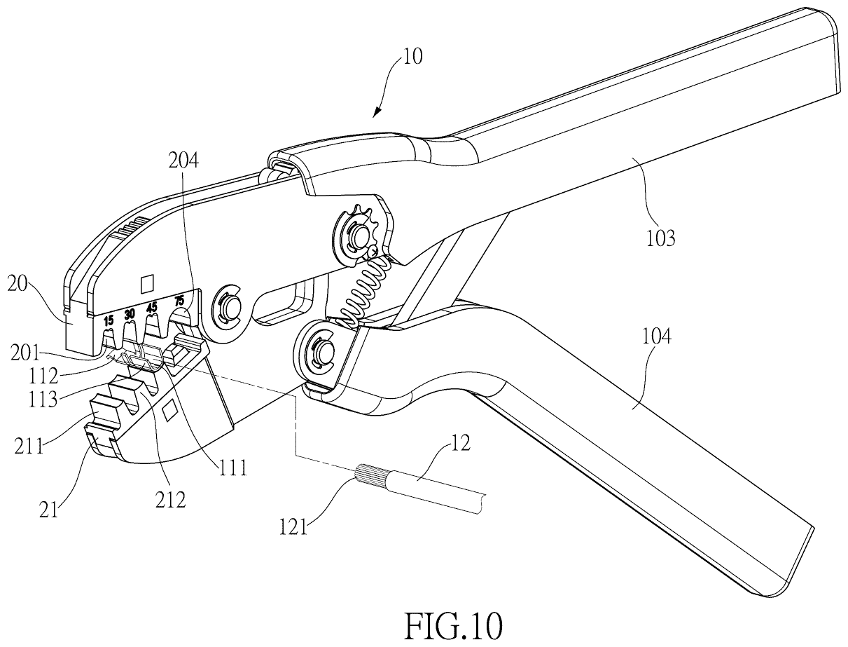

FIG. 11 is a cross-sectional view showing the crimping body placed askew in the conventional crimping plier;

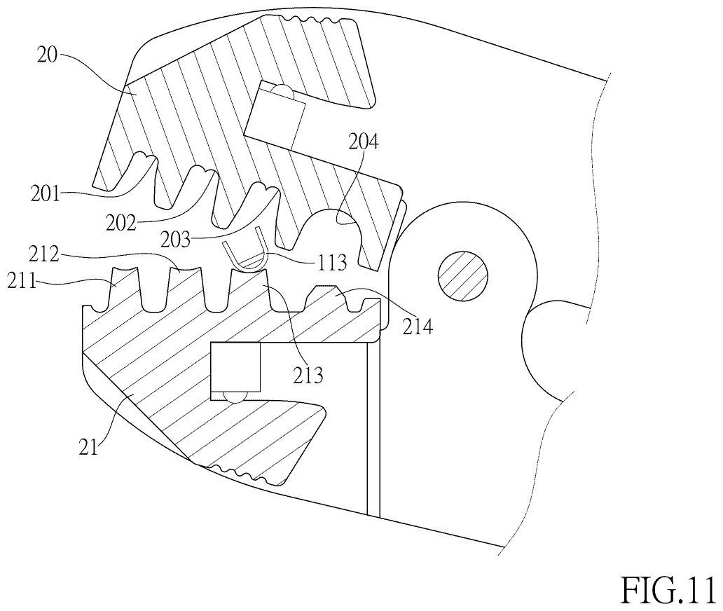

FIG. 12 is a view showing the crimping body not fully covering the transmission line in the conventional crimping plier, and

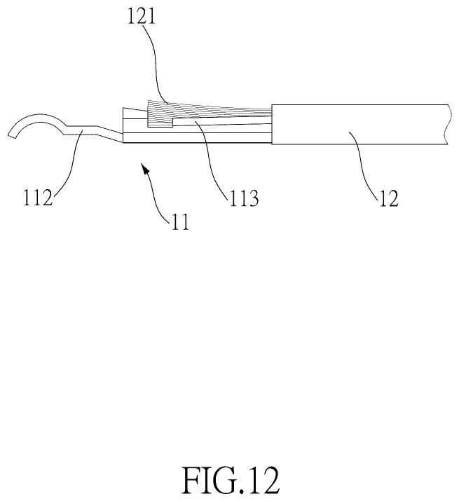

FIG. 13 is a cross-sectional view showing the covering piece not effectively covering the transmission line after pressing in the conventional crimping plier.

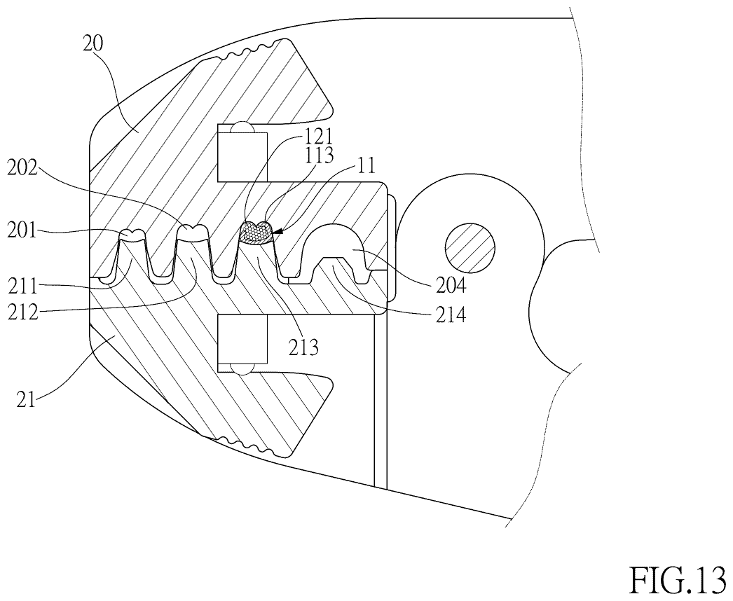

### DETAILED DESCRIPTION OF THE PREFERRED EMBODIMENT

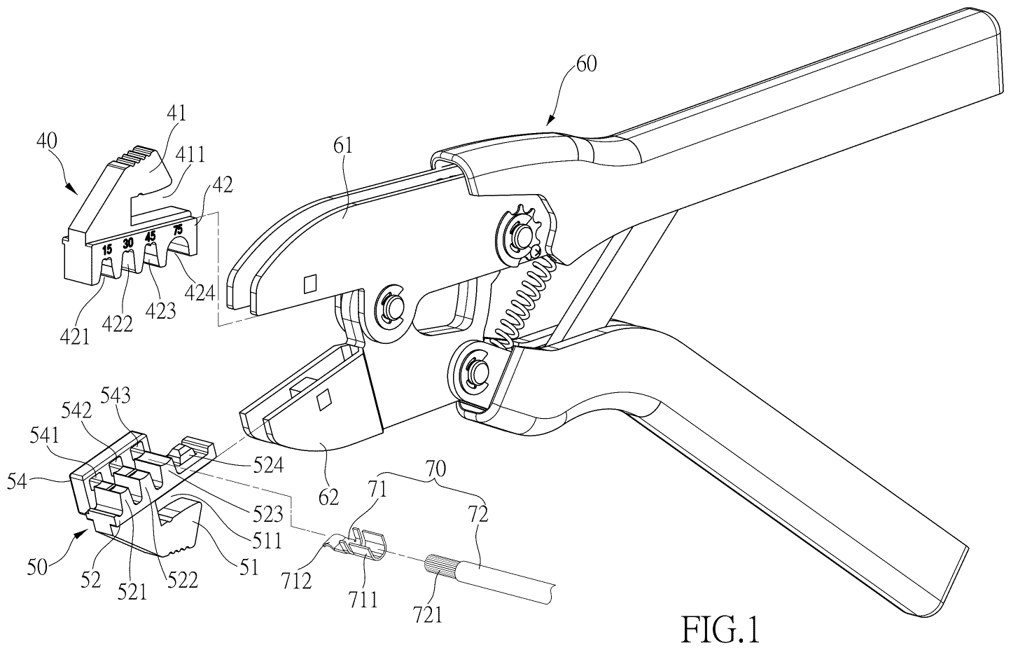

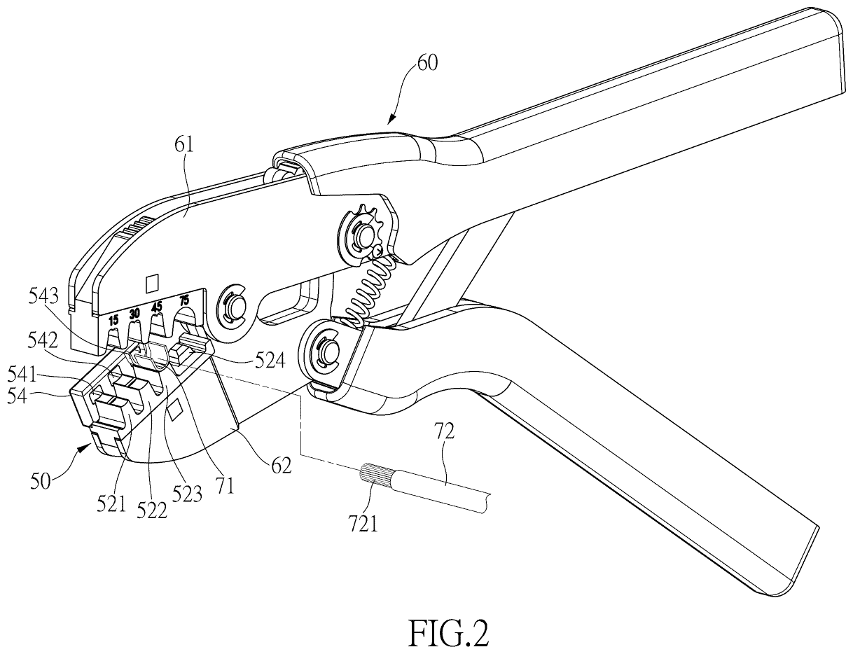

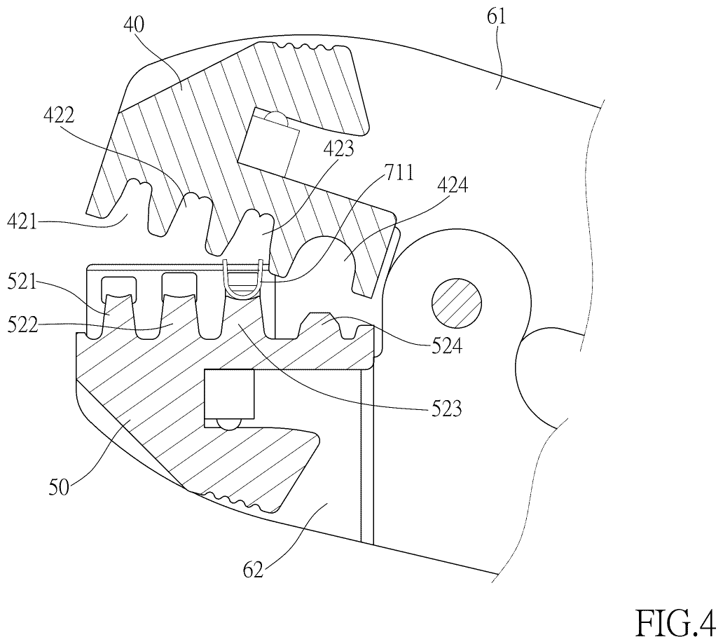

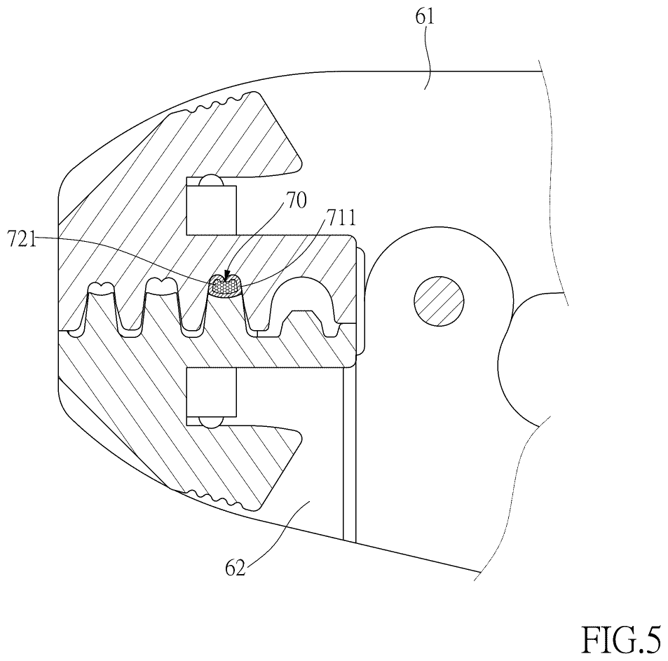

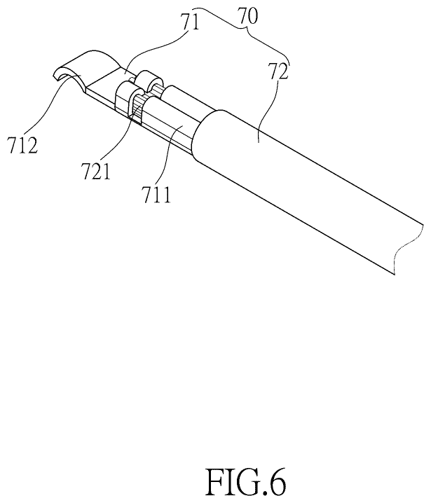

Referring to FIGS. 1 to 6, the mouth film device with integrated positioning for wire-pressing components (70) of the present invention comprises a pair of mouth film bodies (40, 50), each equipped with an upper locking part (41, 51) and a crimping part (42, 52). The upper locking parts (41, 51) have recessed locking grooves (411, 511), which can be used to secure the device to the two side crimping parts (61, 62) of the wire crimping plier (60).

The crimping parts (42, 52) on the other side have several corresponding crimping grooves (421˜424) and crimping protrusions (521˜524) (This embodiment uses four corresponding crimping grooves and protrusions for illustration, but is not limited to four). This allows the compression of the two side crimping parts (61, 62) of the wire crimping plier (60) to press the wire-pressing component (70) using the corresponding crimping grooves (421˜424) and crimping protrusions (521˜524), so as to insert and encapsulate the transmission line (721) of the cable (72) of the wire-pressing component (70) into the covering piece (711) of the crimping body (71). (The wire crimping plier (60), crimping parts (61, 62), and wire-pressing component (70) are all known structures, so no further elaboration is needed.)

On one of the mouth film bodies (50) (this embodiment uses mouth film body (50) for convenient explanation), a surrounding plate body (54) extends from the crimping part (52) side. The surrounding plate body (54) has partial corresponding recessed holes (541˜543) at positions where the crimping protrusions (521˜524) compress onto the corresponding crimping grooves (421˜424). (Here, three recessed holes (541˜543) correspond to three of the crimping positions of the crimping protrusions (521˜524) and crimping grooves (421˜424), without needing to correspond to all crimping positions.)

The height (H) of these recessed holes (541˜543) is smaller than the height (h) of the covering piece (711) of the crimping body (71), while the width (W) of the recessed holes (541˜543) is greater than the width (w) of the extended plate body (712) of the crimping body (71). This allows the covering piece (711) to be secured at the recessed holes (541˜543), while the extended plate body (712) can pass through the recessed holes (541˜543), thus achieving the inventive effect of this invention.

When needing to insert the transmission line (721) of the cable (72) into the covering piece (711) of the crimping body (71), one only needs to first find the appropriate mouth film bodies (40, 50) that match the crimping shape and size (using mouth film bodies (40, 50) for explanation here). After securing these mouth film bodies (40, 50) to the two side crimping parts (61, 62) of the wire crimping plier (60), place the crimping body (71) of the wire-pressing component (70) on the corresponding crimping protrusion (523) (using crimping protrusion (523) for this example).

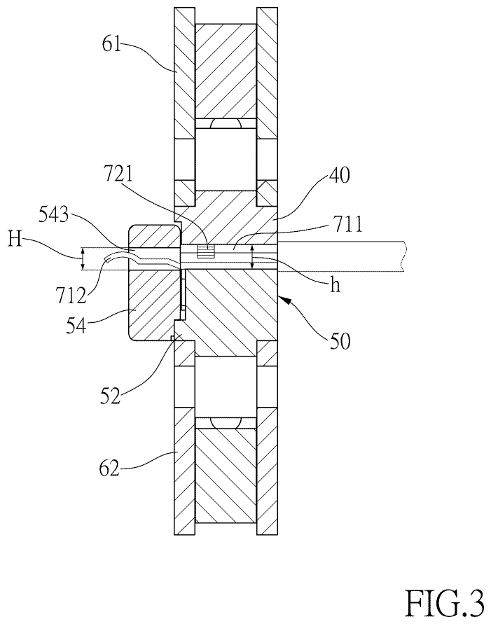

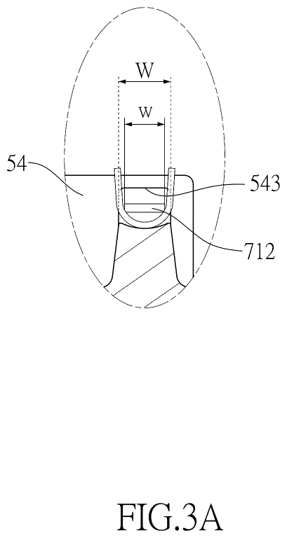

Then, push the wire-pressing component (70) into the corresponding recessed hole (543). Since the height (H) of the recessed holes (541˜543) is smaller than the height (h) of the covering piece (711) of the crimping body (71), and the width (W) of the recessed holes (541˜543) is greater than the width (w) of the extended plate body (712) of the crimping body (71), when pushing the crimping body (71) into the recessed hole (543), the covering piece (711) is secured at the recessed hole (543) (as shown particularly in FIGS. 3 and 3A), while the extended plate body (712) can pass through the recessed holes (541˜543).

Next, close the crimping parts (61, 62) to slightly secure the covering piece (711) of the crimping body (71) of the wire-pressing component (70). Then, insert the transmission line (721) of the cable (72) into the covering piece (711) of the crimping body (71). Finally, apply the necessary force to compress the crimping parts (61, 62). This process allows the transmission line (721) of the cable (72) to be securely and precisely crimped within the covering piece (711) of the crimping body (71) of the wire-pressing component (70), achieving the optimal crimping position and structure.

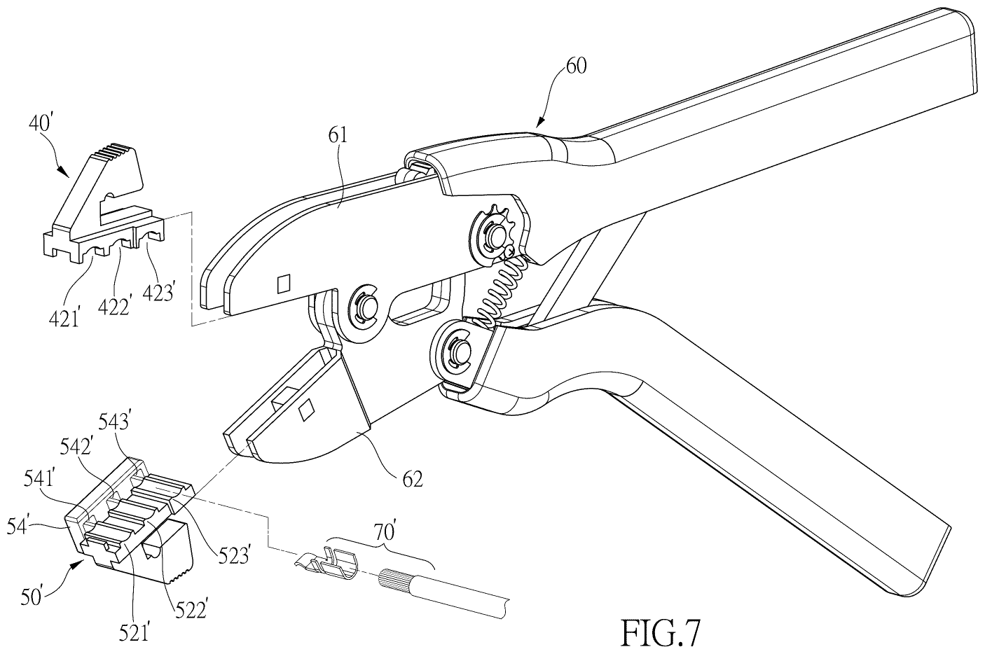

When needing to crimp wire-pressing components (70) of different sizes or shapes, one only needs to detach the mouth film bodies (40, 50) from the two side crimping parts (61, 62) of the wire crimping plier (60), and replace them with different mouth film bodies (40′, 50′), securing them to the crimping parts (61, 62) of the wire crimping plier (60). By utilizing the different shapes and sizes of the corresponding crimping grooves (421′˜423′) and crimping protrusions (521′˜523′) set in these mouth film bodies (40′, 50′) (this embodiment uses three corresponding crimping grooves (421′˜423′) and crimping protrusions (521′˜523′) as an example), and using the mouth film body (50′) with the surrounding plate body (54′) and recessed holes (541′˜543′) to correspond with the other mouth film body (40′), one can achieve the effect of positioning and crimping different wire-pressing components (70′) according to the previously described implementation method. As shown in FIG. 7, this demonstrates a completely simple and effective usage.

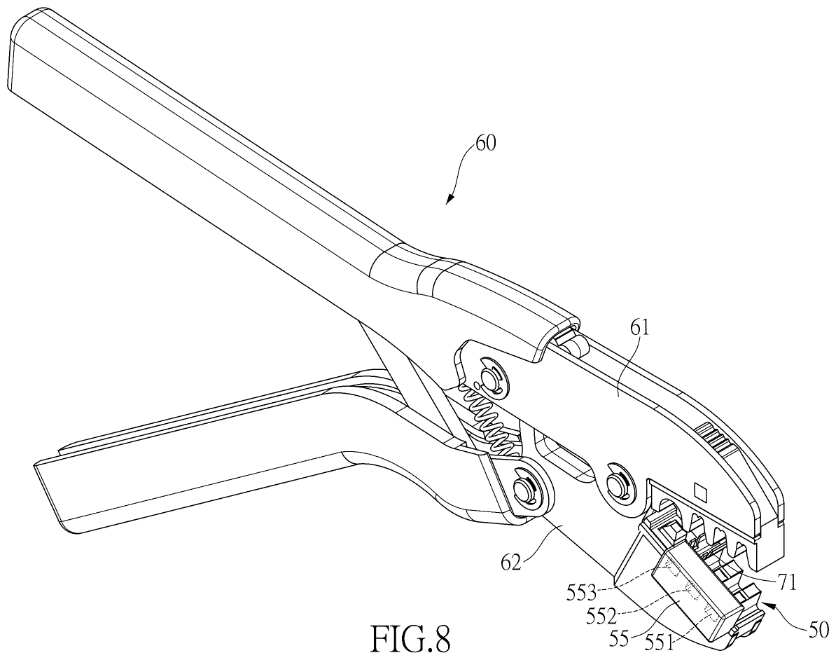

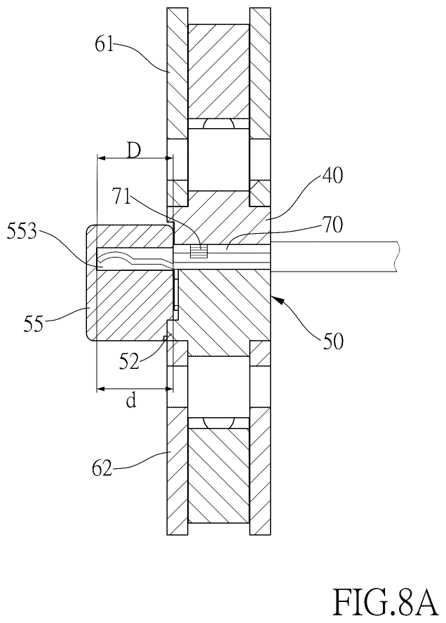

Please also refer to FIGS. 8 and 8A for the second embodiment of the present invention, which modifies the structure of the surrounding plate body (55). Also, refer to the related structures of mouth film body (40), mouth film body (50), and wire-pressing component (70) in FIG. 1. In this embodiment, the surrounding plate body (55) has corresponding recessed grooves (551˜553) at certain positions where the crimping protrusions (521˜524) compress onto the corresponding crimping grooves (421˜424). (Here, three recessed grooves (551˜553) correspond to three of the crimping positions of the crimping protrusions (521˜524) and crimping grooves (421˜424), without needing to correspond to all crimping positions.) These recessed grooves (551˜553) allow the wire-pressing component (70) to fall in and be secured, achieving the inventive effect of this invention. Additionally, if the depth (D) of the recessed grooves (551˜553) is made not greater than the length (d) from the extended plate body (712) to the covering piece (711) of the crimping body (71), it can provide even more stable securing of the wire-pressing component (70).

In the usage of this second embodiment, similarly, one can first place the crimping body (71) of the wire-pressing component (70) on the corresponding crimping protrusion (523) (using crimping protrusion (523) for this example). Then, push the wire-pressing component (70) into the corresponding recessed groove (553). Since the depth (D) of the recessed groove (553) is less than the length (d) from the extended plate body (712) to the covering piece (711) of the crimping body (71), when pushing the crimping body (71) into the recessed groove (553), it will cause the crimping body (71) to fall to a preset depth position. This achieves the necessary predetermined depth for positioning.

Following the same operation as in the first embodiment, the transmission line (721) of the cable (72) can be prepared and securely crimped within the covering piece (711) of the crimping body (71) of the wire-pressing component (70), achieving the optimal crimping position and structure.

While we have shown and described the embodiment in accordance with the present invention, it should be clear to those skilled in the art that further embodiments may be made without departing from the scope of the present invention.

What is claimed is:

1. A mouth film device used for crimping a crimping body (71) and a cable (72) of a wire-pressing component (70), the crimping body (71) having a covering piece (711) and an extended plate body (712), a transmission line (721) of the cable (72) passing through the covering piece (711), the mouth film device comprising:
two mouth film bodies (40, 50), each having an upper locking part (41, 51) and a crimping part (42, 52), wherein each upper locking part (41, 51) has a recessed locking groove (411, 511), and each crimping part (42, 52) has several corresponding crimping grooves (421˜424) and crimping protrusions (521˜524), and
one of the mouth film bodies (40, 50) having an extended surrounding plate body (54) on a side located close to the crimping protrusions (521˜524), when the crimping protrusions (521˜524) are pressed together, the surrounding plate body (54) has recessed holes (541˜543) located corresponding to the crimping grooves (421˜424), wherein a height (H) of each recessed hole (541˜543) is smaller than a height (h) of the covering piece (711) of the crimping body (71), a width (W) of each recessed hole (541˜543) is greater than a width (w) of the extended plate body (712) of the crimping body (71).

2. A mouth film device comprising:
two mouth film bodies (40, 50), each having an upper locking part (41, 51) and a crimping part (42, 52), each upper locking part (41, 51) having a recessed locking groove (411, 511), each crimping part (41, 52) having several corresponding crimping grooves (421˜424) and crimping protrusions (521˜524), and
one of the mouth film bodies (40, 50) having an extended surrounding plate body (55) on a side located close to the crimping protrusions (521˜524), when the crimping protrusions (521˜524) are pressed together, the surrounding plate body (55) has recessed grooves (551˜553) located corresponding to the crimping grooves (421˜424), wherein a wire-pressing component (70) is secured by falling into the recessed grooves (551˜553).

3. The mouth film device as claimed in claim 1, wherein the depth (D) of the recessed grooves (551˜553) is less than a distance (d) from the extended plate body (712) to the covering piece (711) of the crimping body (71).
